(19) United States
(12) Patent Application Publication
(10) Pub. No.: US 2006/0186266 A1
(43) Pub. Date: Aug. 24, 2006

(54) Multipurpose model-aircraft launching apparatus

(75) Inventor: Christopher Alwyn Kennedy, Victoria (AU)

Correspondence Address: David W. Heid;MacPHERSON KWOK CHEN & HEID LLP, Suite 226, 1762 Technology Drive, San Jose, CA, 95110, US

(73) Assignee: AVICADE INDUSTRY PTY LTD

(21) Appl. No.: 11/361,262

(22) Filed: Feb. 24, 2006

(30) Foreign Application Priority Data
Feb. 24, 2005 (AU) 2005200800

(51) Int. Cl. B64F 1/04

(52) U.S. Cl. 244/63

(57) ABSTRACT

A launching apparatus is adapted to provide a short runway surface which is used to launch a flying model aircraft. The launching apparatus is also provided with a cavity to store the model aircraft when the launching apparatus is not in use. Thus, the launching apparatus functions as a launcher, as a means of storage and transportation for the model aircraft.

### CROSS-REFERENCE TO RELATED APPLICATION

This application claims priority from Australian patent application Number 2005200800, filed on Feb. 24, 2005, the contents of which are incorporated herein by reference in their entirety.

### FIELD OF INVENTION

The present invention relates to launching apparatus for model aircraft, such as radio-controlled flying model airplanes or other miniature aircraft or air-vehicles.

### BACKGROUND OF INVENTION

In order to aid the launch of a flying model aircraft, such as a radio-controlled model, the aircraft is typically positioned on an apparatus that acts as a very short runway. The length of the runway is typically around a meter or so in length, but it can vary depending on the particular model aircraft.

To give the model aircraft its initial acceleration at take-off, the aircraft is connectable to the end of an elastic cord that is held very taut. When the plane is released, the elastic cord contracts and pulls the aircraft off the short runway at sufficient speed to launch the model aircraft.

The launching process is similar to the launching of military aircraft from the very short runways on aircraft carriers, at least in the sense that a very short runway is sufficient to launch the model airplane, given the extreme acceleration that is imparted to the model aircraft by the elastic cord.

The apparatus, which acts as the very short runway for the model aircraft, is known as a launcher.

If the aircraft were to take off on its own power, the model airplanes would typically need a runway of around 30 to 100 meters. The model aircraft would also be provided with landing gear and wheels to run along this long runway. In contrast, when the model aircraft is given the initial acceleration by the elastic cord, the length of the runway can be shortened to around a meter or thereabouts, but even this results in a launcher that is relatively sizeable.

The size of these prior art model aircraft launchers therefore involves a degree of inconvenience, and even difficulty, when the user has to carry a range of equipment, such as the model airplane itself, as well as the launcher.

Often, radio-controlled model aircraft are launched in fields, parks and other wide-open spaces. Thus, the user may have to carry quite a few bulky items for some distance, which can detract somewhat from the enjoyment of flying these model aircraft.

### SUMMARY OF INVENTION

According to an aspect of the present invention, there is provided a launching apparatus which provides a short runway for launching a flying model aircraft, the apparatus including:

at least one runway-surface-component which has a runway-surface-portion,

wherein, in use in a launch-arrangement, the runway-surface-portion functions as a short runway on which a model aircraft can be launched,

wherein the at least one runway-surface-component is provided with container-means adapted to function as a storage container for the model aircraft, when the apparatus is in a storage-arrangement and not in use for launching.

Preferably, the apparatus includes two or more runway-surface-components each having a runway-surface-portion,

wherein, in use in the launch-arrangement, each of the runway-surface-portions combine to form said short runway, and

wherein the two or more runway-surface-components each is provided with container-means such that, when the apparatus is in the storage-arrangement and not in use for launching, the container-means of each of the two or more runway-surface-components combine to form said storage container for the model aircraft.

The two or more runway surface portions, in use in the launch-arrangement, may be arranged side by side to form said short runway.

The two or more runway surface components may be pivotally connected one to another.

The two or more runway surface components may be pivotally connected by a hinge mechanism.

The apparatus may have two runway surface components that are operable between the launch-arrangement and the storage-arrangement in a manner of a V-shaped hinge.

In other embodiments, the apparatus may have three runway surface components that are operable between the launch-arrangement and the storage-arrangement in a manner of two V-shaped hinges each located at either end of a central component.

In other modifications, the two or more runway surface components may be able to be arranged in sliding arrangement one with another.

The two or more runway surface components may be fastenable to each other when in either the launch-arrangement for launching, or the storage-arrangement for storage, but may be otherwise disconnected.

In use, the short runway may include linear-guide-means for guiding the aircraft along the runway during launching.

The linear-guide-means may include one or more track elements.

Alternatively, the linear-guide-means includes one or more linear grooves.

Preferably, the aircraft is launched from the launching apparatus by launching-force-means.

Preferably, he launching-force-means is an elastic cord connectable to the model aircraft.

Preferably, he apparatus is provided with cord-restraining-means adapted, in use prior to launching, to hold and restrain the elastic cord.

Preferably, the cord-restraining-means is releasable by a foot-activated actuator.

Preferably, the cord-restraining-means is releasable by a hand-activated actuator.

Preferably, the cord-restraining-means is an external component that is separate to the apparatus.

Alternatively, the cord-restraining-means may be an integral component of the apparatus.

Preferably, the apparatus is further provided with safety-cord-restraining-means adapted, in use prior to launching, to hold and restrain the elastic cord independently of the cord-restraining-means.

Alternatively, the launching-force-means may be a motor on the model aircraft.

In other modifications, the apparatus may include three or more runway surface component.

Preferably, the apparatus includes handle-means to allow the user to hand-carry the launching apparatus when the apparatus is arranged in the storage-arrangement.

The storage-arrangement may be useable as a transport-arrangement for transporting the apparatus.

According to another aspect of the present invention, there is provided a launching apparatus that is provided with a short runway surface which, in use, is used to launch a flying model aircraft wherein the launching apparatus is provided with a cavity to store the model aircraft therein when the launching apparatus is not in use.

According to a further aspect of the present invention, there is provided use of a launching apparatus to launch a flying model aircraft from a short runway surface provided on the launching apparatus and use of the same launching apparatus to store the flying model aircraft within the launching apparatus.

According to yet a further aspect of the present invention, there is provided a method of launching a model aircraft from a launching apparatus and storing the aircraft in the same apparatus, the method including:

providing a launching apparatus which, in a launch-arrangement, provides a short runway for launching a flying model aircraft, the apparatus including at least one runway-surface-component which has a runway-surface-portion that functions as the short runway;

launching the aircraft from the runway-surface-portion; and

re-arranging the launching apparatus into a storage-arrangement and storing the aircraft in container-means that is included in the at least one runway-surface-component.

### DRAWINGS

In order that the present invention might be more fully understood, embodiments of the invention will be described, by way of example only, with reference to the accompanying drawings, in which:

FIG. 1 is a perspective view of an embodiment of a box-launching apparatus shown in a launch-arrangement;

FIG. 2 is a perspective view of the box-launching apparatus of FIG. 1, shown with a model aircraft ready for launching;

FIG. 3 is a close-up perspective view of the of the box-launching apparatus of FIG. 1, shown with the model aircraft ready for launching;

FIG. 4A is a side view of the box-launching apparatus of FIG. 1;

FIG. 4B is a plan view of the box-launching apparatus of FIG. 1;

FIG. 4C is a front view of the box-launching apparatus when viewed from arrow A of FIG. 4B;

FIG. 4D shows a rear view of the box-launching apparatus when viewed from arrow B of FIG. 4B;

FIG. 5A is a perspective view of the box-launching apparatus of FIG. 1 when in a storage-arrangement;

FIG. 5B is a perspective view of the box-launching apparatus of FIG. 1 when it is being opened up, in an intermediate arrangement that is between the launch and the storage arrangements;

FIG. 5C is a similar view to FIG. 5B, except shown with the legs positioned ready for use, but with the model aircraft and external release pedal having been removed from the box;

FIG. 6A is a perspective view of a further embodiment that has three flat-casings;

FIG. 6B is a perspective view of another embodiment in between its launch and storage arrangements;

FIG. 6C is a perspective view of the embodiment of FIG. 6B in a fully launch-arrangement;

FIG. 6D is a side view of a further embodiment of a box-launching apparatus shown in a launch-arrangement;

FIG. 6E is a side view of yet a further embodiment of a box-launching apparatus shown in a launch-arrangement;

FIGS. 7A, 7B and 7C are a series of drawings showing the embodiment of FIG. 1 in various stages of the pre-launch procedure;

FIGS. 8A, 8B1, 8B2 and 8C respectively are the perspective, side view, see-through side view, and top plan view of an external release pedal of the embodiment of FIG. 1;

FIGS. 9A, 9B1, 9B2, 9C1, 9C2, 9D1 and 9D2 are a series of views of another embodiment of a release pedal implemented in which the pedal is an integral part of the box-launcher. Respectively the views are the undersurface perspective, side, side see-through, top, top see-through, front, and front see-through views; and

FIGS. 10A, 10B1, 10B2, 10C1, 10C2, 10D1 and 10D2 are a series of views of a further embodiment of further alternative internal release pedals. Respectively the views are the undersurface perspective, side, side see-through, top, top see-through, front, and front see-through views

### DESCRIPTION OF EMBODIMENTS

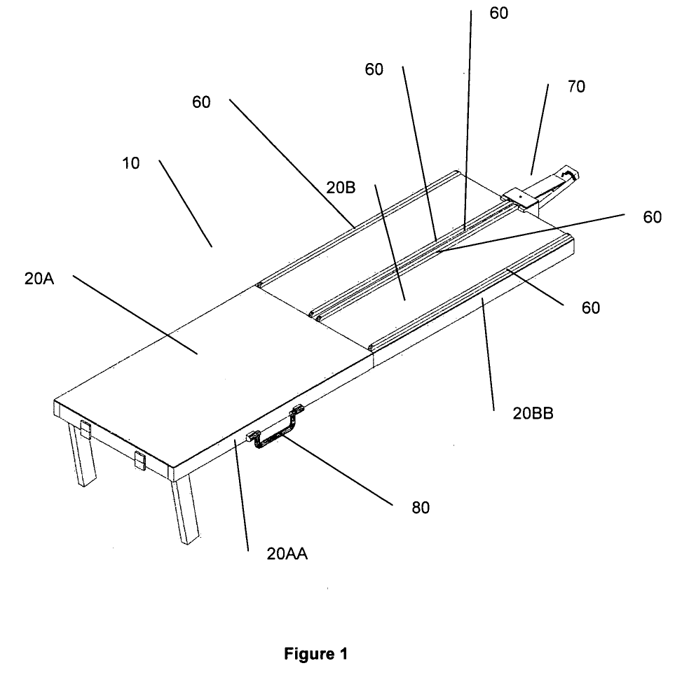

Referring to the accompanying drawings, FIG. 1 shows a perspective view of an embodiment of a launching apparatus in the form of box-launcher 10.

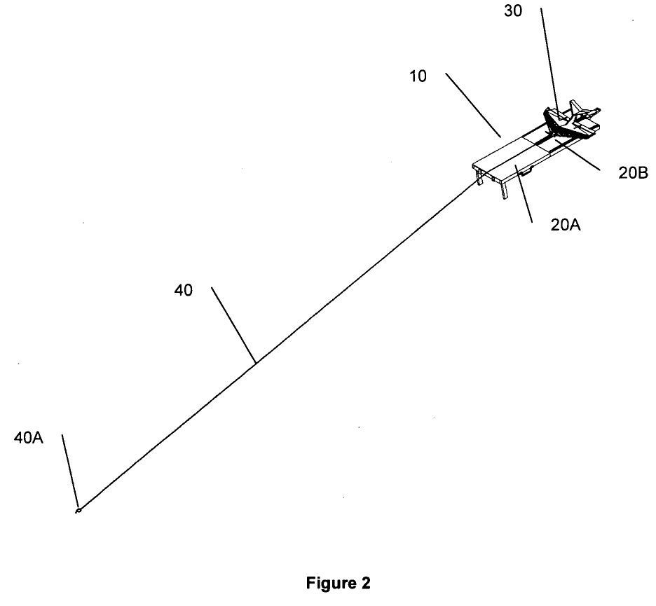

The box-launcher 10 provides a short runway that is used to launch a flying model aircraft 30, as shown in FIG. 2.

In order to provide this short runway, the box-launcher 10 has at least a runway-surface-component. In the embodiment of FIG. 1, the box-launcher 10 has two runway-surface-components, in the form of a first flat-casing 20AA and a second flat-casing 20BB.

Launch and Storage Arrangements

By way of introduction, the overall concept of present embodiment is that the components 20AA, 20BB, which make up the short runway 20A, 20B, also have a duplicate function of acting as a storage container for the same aircraft 30. (Hence, the name “box-launcher”, since it functions as a launcher for the aircraft, as well as a box for the same aircraft). The box-launcher 10 is a portable launch system that also houses the model aircraft when not in use. The box-launcher 10 stores and transports the model aircraft, and is also used to launch the vehicle or aircraft.

By allowing the launcher to function also as a storage container for the aircraft, it minimizes the number of items that the user has to carry around, particularly when the items have to be carried across large distances. In other words, the user no longer has to carry a box for the aircraft and a launcher.

To achieve this dual function, the box-launcher 10 is operable between a launch-arrangement and a storage-arrangement. The launch-arrangement is that state where the components function as a launcher for the aircraft, while the storage-arrangement is that state where the same components function as a storage container for the aircraft.

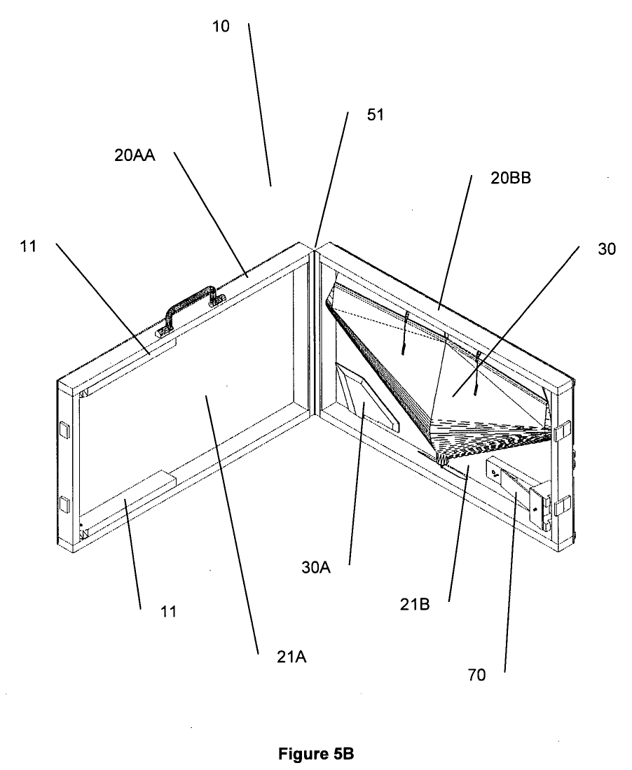

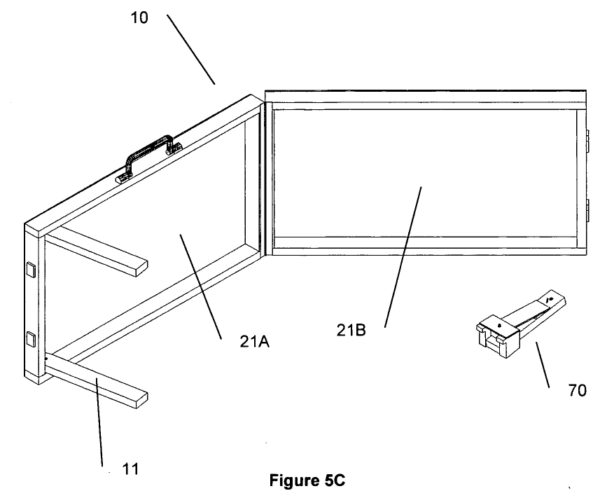

The launch-arrangement is shown in FIGS. 1, 2, 3 and 4A to 4D. The storage-arrangement is shown in FIG. 5A. Also, this storage-arrangement moreover enables the box-launcher 10, and its contents, to be more readily transported. Hence, in a sense, the storage-arrangement may be regarded as a transport-arrangement.

In the launch-arrangement of FIG. 1, the box-launcher 10 acts as a launching runway for the aircraft 30.

In the storage-arrangement of FIG. 5A, the same box-launcher 10 acts as a box or container for the aircraft 30.

FIGS. 5B and 5C shows intermediate states, in between the launch-arrangement of FIGS. 1 to 4, and the storage-arrangement in FIG. 5A.

FIG. 5B shows the model aircraft 30, its fin 30A, and external release pedal 70, all stored inside the container of the box-launcher 10.

Dual-Function: Forming the Launch Runway

In order for the first flat-casing 20AA and a second flat-casing 20BB to provide this short runway, each of the casings has a runway-surface-portion in the form of runway-surfaces 20A, 20B. These runway-surfaces 20A, 20B are located at the top of each casing 20AA, 20BB.

In use, when in the launch-arrangement of FIGS. 1 to 4, these runway-surfaces 20A, 20B align with each other, and combine to form the unified, flat, short runway, on which a model aircraft 30 can be launched.

In FIGS. 1 to 4, showing the box-launcher 10 in its launch-arrangement, the runway-surfaces 20A, 20B are arranged side by side to form the short runway for launching the flying model aircraft 30.

Dual-Function: Forming the Container

For the box-launcher to also function as a container, each of its first and second flat-casings 20AA, 20BB includes container-means.

When the box-launcher is in the storage-arrangement, the container-means of each of the flat-casings 20AA, 20BB combine to form a storage container for the model aircraft 30.

In the embodiment of FIGS. 1 to 5, the container-means includes cavities 21A, 21B which are best seen in intermediate arrangement of FIG. 5B. In other words, the first flat-casing 20AA has a cavity 21A, while the second flat-casing 20BB has its own cavity 21B.

In the storage-arrangement of FIG. 5A, the two cavities 21A, 21B combine with each other to form the storage container for the model aircraft.

In other embodiments, the cavity may be only provided in one of the multiple flat-casings, rather than having a cavity on each.

Launching

The aircraft 30 is launched by launching-force-means. In FIG. 2, the launching-force-means is an elastic cord 40. The cord is attachable to the aircraft 30.

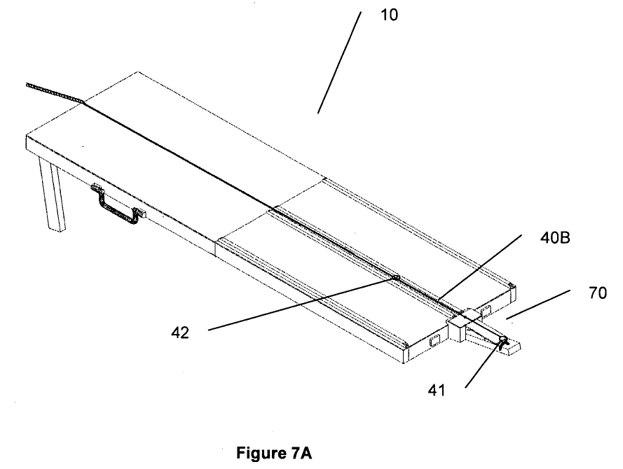

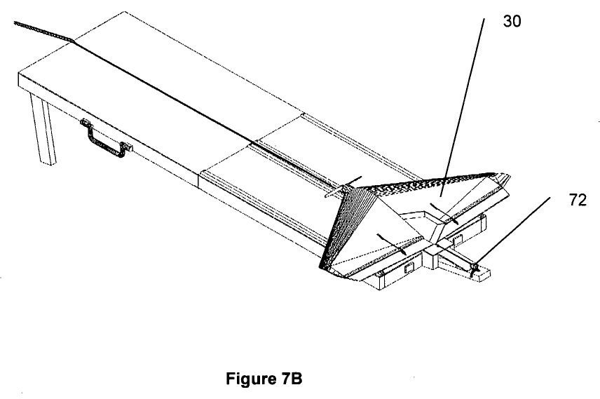

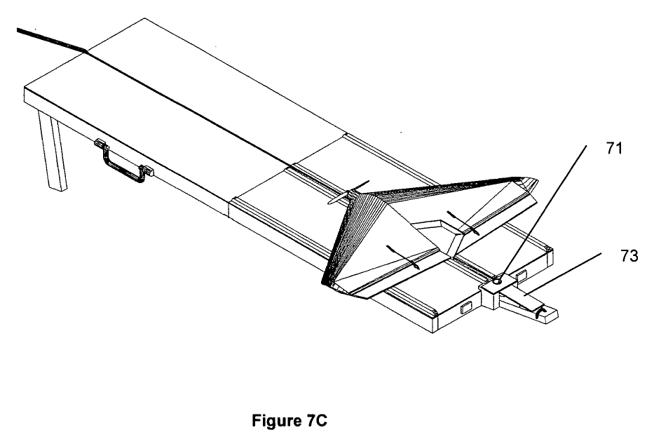

In FIGS. 2 and 7A, in order to give the model aircraft 30 its initial acceleration at take-off, the aircraft is fitted to a launch ring 42 that is at the other end 40B of the elastic cord 40 that is held very taut. (The launch ring 42 is seen clearly in FIG. 7A).

When the aircraft 30 is released, the elastic cord 40 pulls the aircraft off the short runway 20A, 20B at sufficient speed to launch the model aircraft into flight.

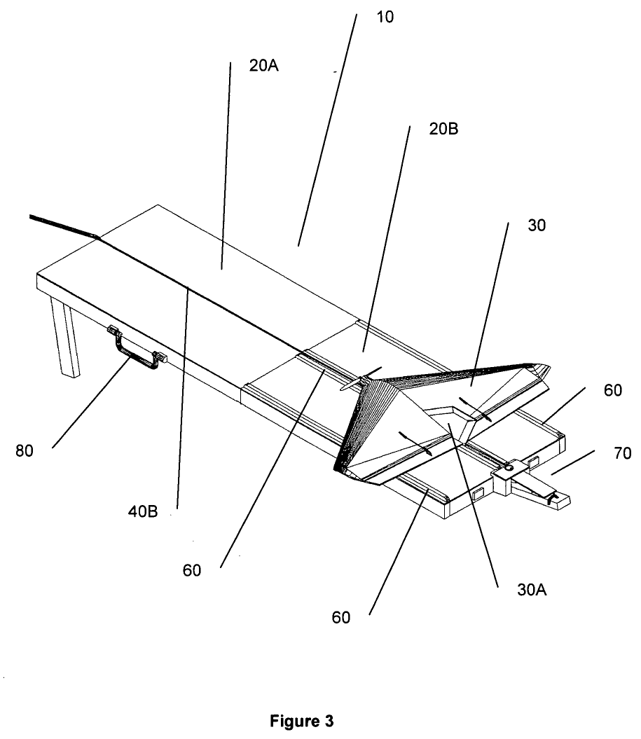

FIG. 3 shows a perspective view of the box-launcher 10 with a model aircraft positioned on the short runway 20A, 20B.

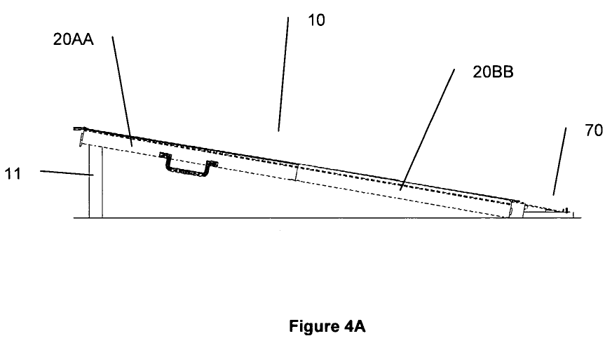

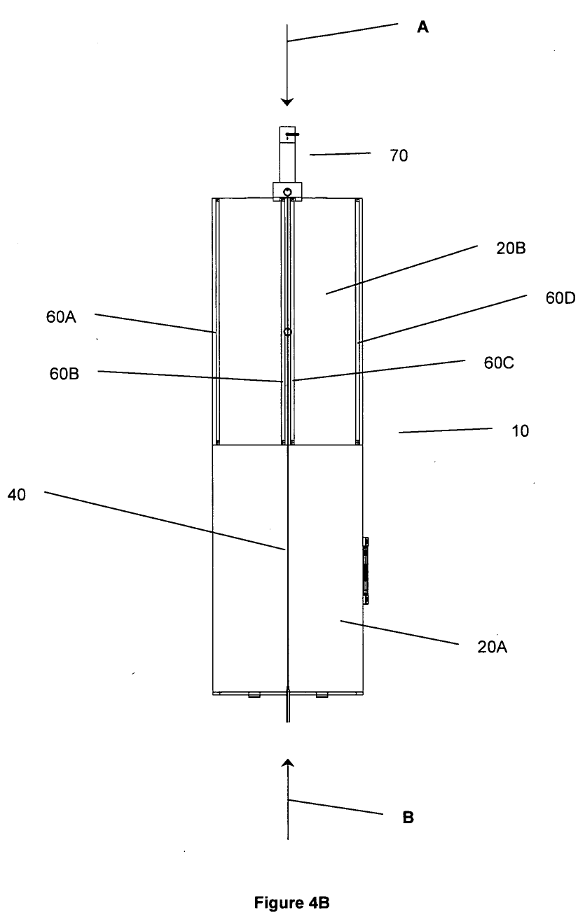

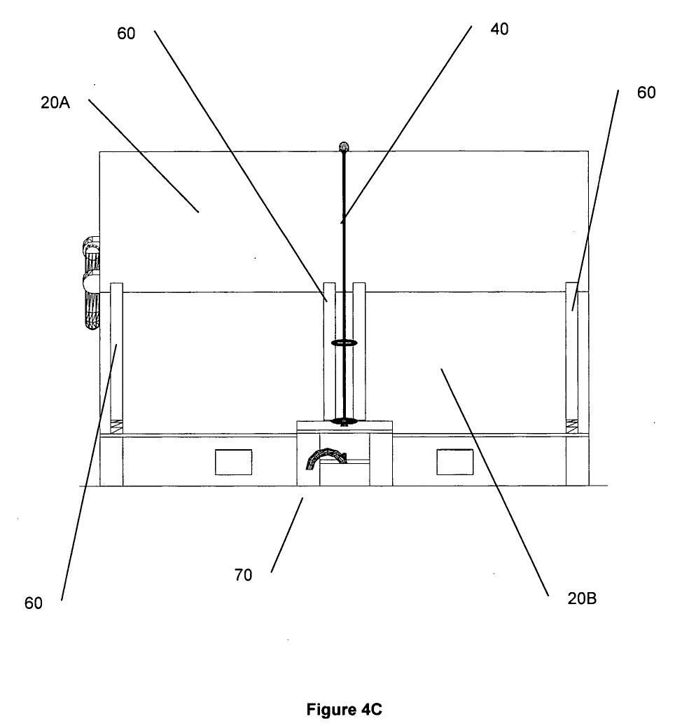

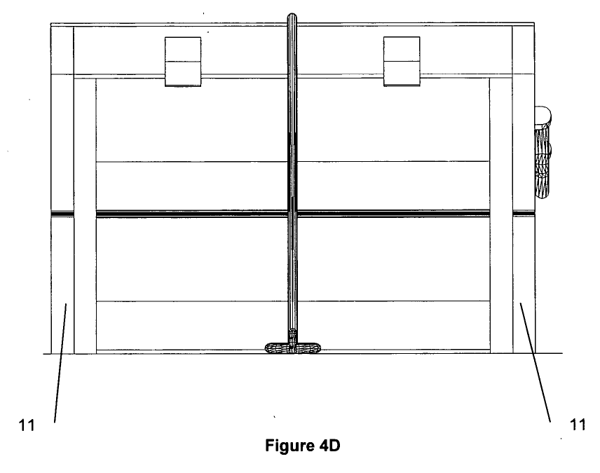

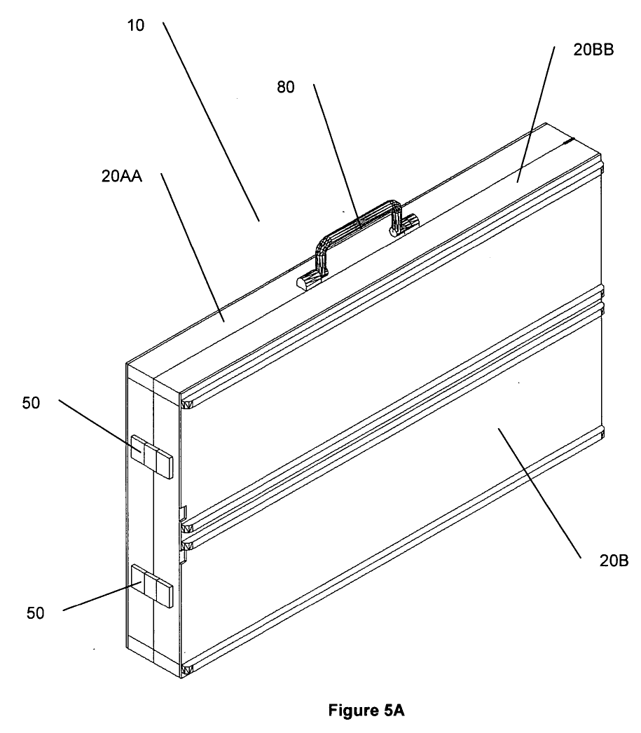

FIG. 4A shows a side view of the box-launcher 10, with the short runway 20A, 20B propped up on a strut 11. This provides an angle of inclination which aids the launching the aircraft 30 from the runway 20A, 20B.

FIG. 4B shows a plan view of the same box-launcher 10.

FIG. 4C shows a front view of the box-launcher 10 when viewed from arrow A of FIG. 4B.

FIG. 4D shows a rear view of the box-launcher 10 when viewed from arrow B of FIG. 4B.

Construction

In the embodiment of FIGS. 1 to 5, the first flat-casing 20AA and a second flat-casing 20BB are pivotally connected one to another. In the embodiment, the two casings are secured by latches 50, seen in FIG. 5A, which allow the user to securely close the box-apparatus 10 when the apparatus is arranged in the transport or storage-arrangement.

In the intermediate states shown in FIGS. 5B and 5C, the first flat-casing 20AA and a second flat-casing 20BB are seen to be operable between the launch-arrangement and the storage-arrangement in a manner of a V-shaped hinge mechanism, seen in FIG. 5B.

Alternative Constructions

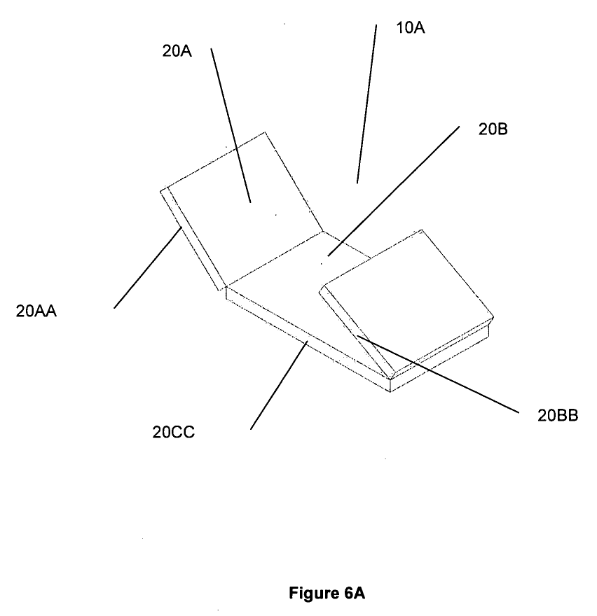

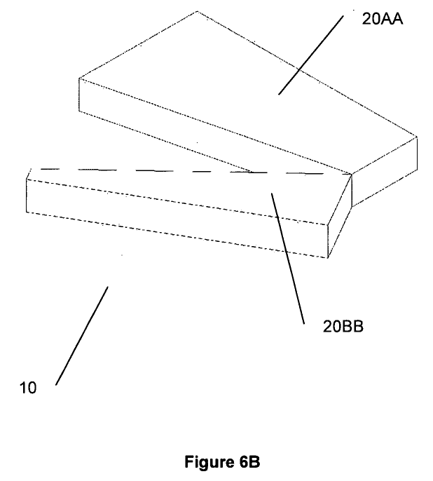

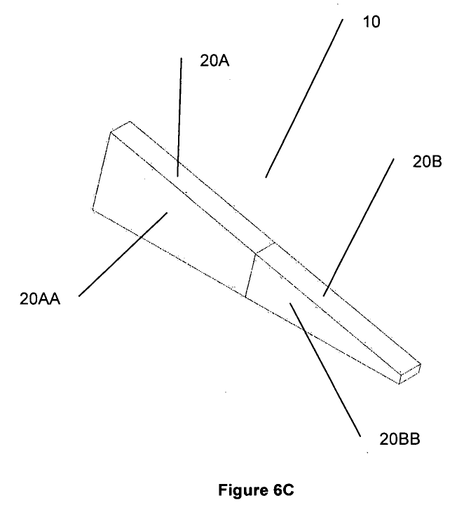

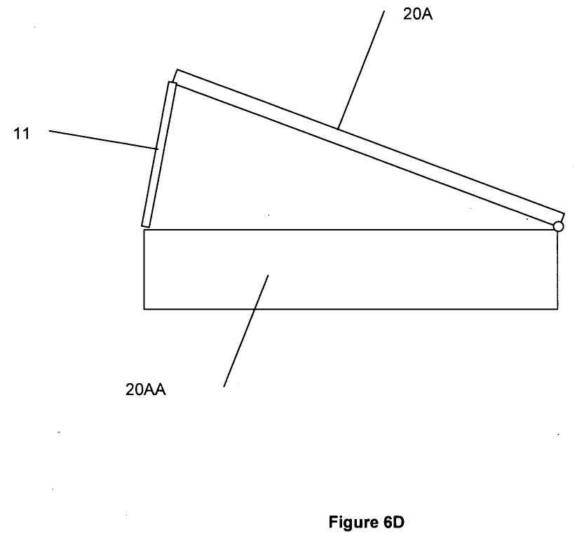

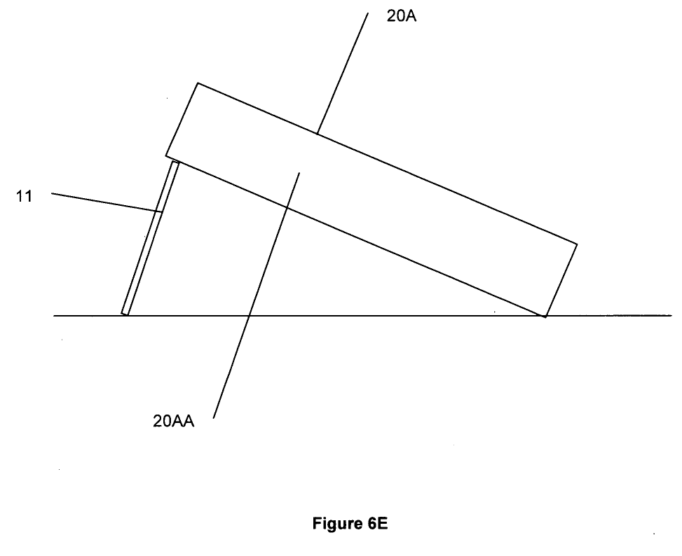

FIGS. 6A to 6D show three examples of other variations, and there are numerous other variations possible that fall within the scope of the invention.

For example, in FIG. 6A, the box-launcher 10A has three flat-casings 20AA, 20BB, 20CC that are operable between the launch-arrangement and the storage-arrangement in a manner of two V-shaped hinges, each located at either end of a central component 20CC.

In FIG. 6A, each of the flat-casings 20AA, 20BB, 20CC have their runway surfaces 20A, 20B, 20C (the latter not visible in FIG. 6A).

FIGS. 6B, 6C and 6D show other possible embodiments, to make the point that there are numerous variations for arranging the flat-casing components.

In the modification of FIG. 6D, the flat-casing 20AA is separate from its runway-surfaces 20A. In such a modification, the opening into the cavity, that is used to contain the aircraft, can be directly under the runway-surfaces 20A.

In another variation of FIG. 6D, the opening can be on one of the lateral sides. In other words, in other embodiments, there is no strict requirement that the runway-surfaces 20A must itself be used to close or seal the cavity.

FIG. 6E is a side view of yet a further embodiment of a box-launching apparatus shown in a launch-arrangement. This embodiment has one flat-casing 20AA that has one runway-surface 20A. The storage area is inside the casing 20AA, which is accessed by an opening in a lateral side of the casing.

There are also numerous variations of the actual number of the flat-casing components, and their shape.

Also, in other variations, some components may only play a role in the casing-means, while others may only play a role of providing a runway-surface-portion for the runway. For instance, the container-means could include a flat hinged side lid that does not participate in the function of providing the runway.

In other modifications, the invention is not limited to pivotal arrangements. In other modifications, the runway surface components can slide with respect to one with another, akin to a chest of drawers.

Also, in other modifications, the various components of the box-launcher 10 need not be hinged to one another. For example, in FIG. 6D, the flat-casing 20AA can be designed to be separated from its runway-surfaces 20A, and connected using a slot-in-groove arrangement rather than a hinge connection, for example.

In the embodiment of FIG. 1, the first flat-casing 20AA and a second flat-casing 20BB are permanently fastened or hinged to one another. However, in other modifications, the casings can be fastened when in the launch-arrangement, and perhaps in the storage-arrangement too, but are otherwise disconnected.

Runway

In the embodiment of FIG. 1, the short runway is made up of the two runway-surfaces 20A, 20B.

The runway includes linear-guide-means in the form of linear track elements 60. These linear tracks 60 guide the aircraft along the runway during launching.

There can be one or more track elements. In the embodiment of FIGS. 1 and 4B, there are four tracks 60. The four tracks 60 are strips of material with a 9 mm×9 mm square cross section, with the ends filleted to avoid catching when coming into contact with other items. In FIG. 4B, the two center tracks 60B, 60C keep the aircraft's launch hook (and therefore the aircraft) moving in line with the longitudinal axis of the box-launcher. The two outer tracks 60A, 60D prevent the aircraft from rolling over into a turn at the instant of launch.

In other embodiments, the linear guide-means can be in the form of one or more linear grooves in which some part of the plane rides during the launch. In such embodiments with grooves, there would be no need for the linear tracks.

Launch Mechanism

In use, the aircraft 30 is launched by firstly tensioning the elastic cord 40.

In FIG. 2, one end 40A of the cord 40 is pegged to the ground far away from the box-launcher 10.

The box-launcher 10 is provided with cord-restraining-means in the form of an external release pedal 70. This release-pedal, prior to launching, holds and restrains the elastic cord 40.

Safety-Mode and Release-Mode

FIGS. 7A and 7B shows the apparatus in a “safety-mode”, while FIG. 7C shows the same apparatus in a “release-mode”. In the safety-mode, even if the springboard foot-pedal 73 is accidentally depressed, the aircraft will not launch. Only when the apparatus is in the launch-mode can the aircraft be actually launched.

FIG. 7A shows that the end 40B of the cord 40 is provided with two rings: a release-ring 41, and a launch ring 42. The aircraft is attached to the launch-ring 42. The release-ring 41 is the one that is held by the release pedal 70 prior to launch.

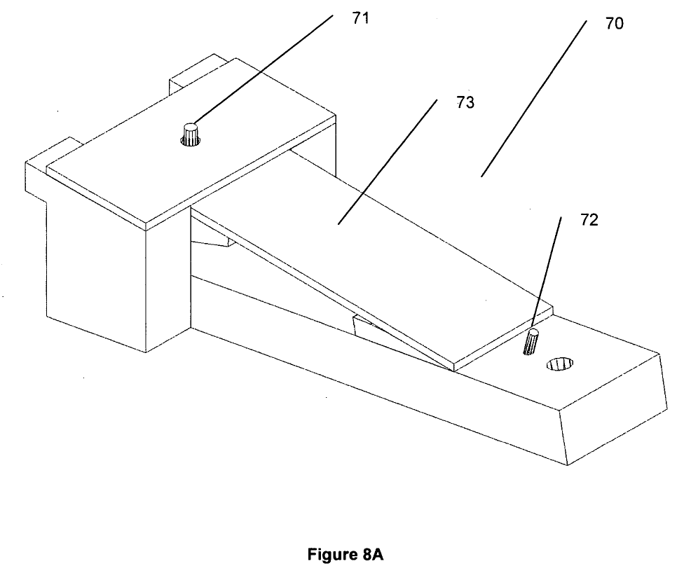

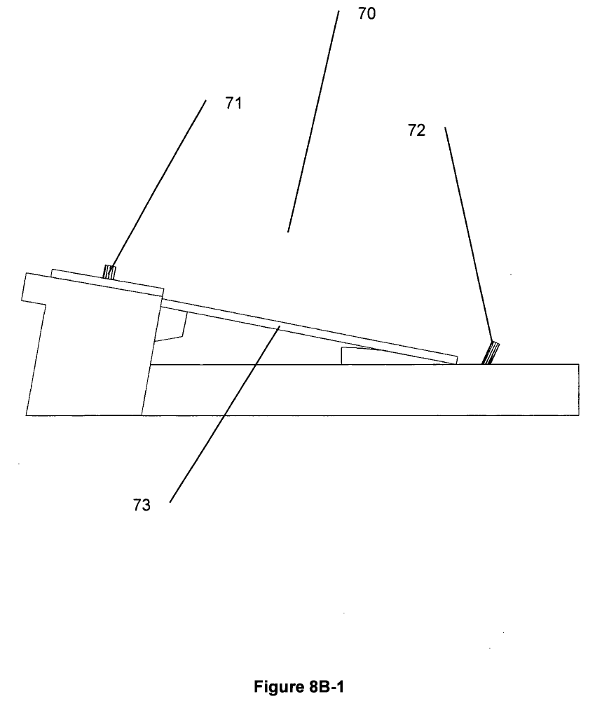

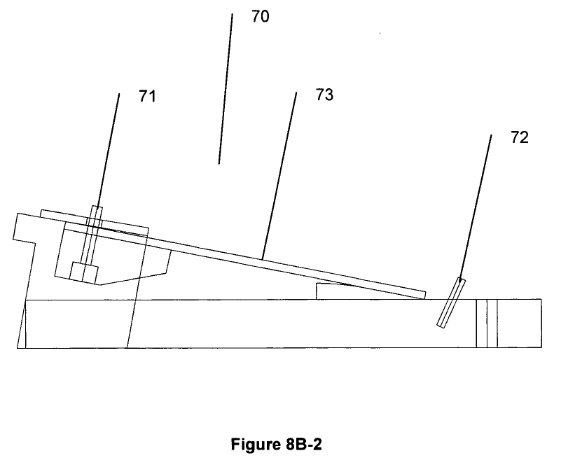

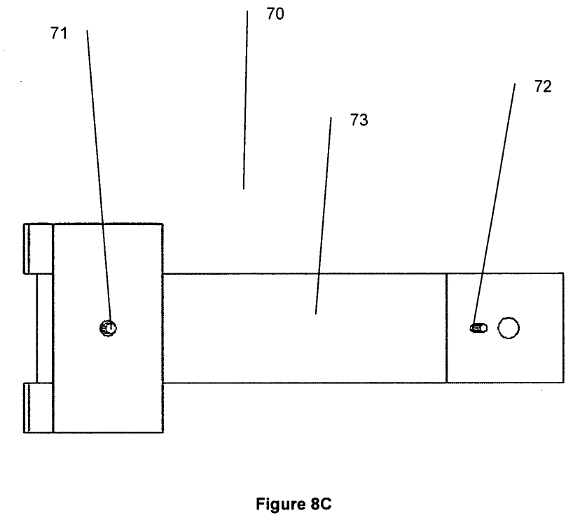

Figure FIGS. 8A, 8B1, 8B2 and 8C are respectively the perspective, side view, see-through side view, and the top view of the external release pedal 70.

The function of the release-ring 41 is to fit onto the release pedal 70, such that when the release pedal is depressed, the release-ring 41 is suddenly set free so as to cause the aircraft to be launched.

In contrast, the function of the launch ring 42 is to releasably and temporarily hold the aircraft to the cord 40 for the short moment of time at the instant of initial acceleration.

In FIG. 7A, the release-ring 41 is hooked to a safety-pin 72 of the release-pedal 70. This is done before the aircraft is placed on the runway. In this stage in FIG. 7A, the apparatus is regarded as being in safety-mode. The safety-pin 72 is adapted to restrain the release-ring 41, irrespective of whether or not the foot-pedal 73 is depressed. This is to avoid a case where the aircraft is launched accidentally if the user accidentally steps on the foot-pedal 73.

While in this safety-mode, the next step is that the underside of the aircraft 30 is fitted or hooked to the launch-ring 42, as shown in FIG. 7B. FIG. 7B shows the apparatus in this safety mode, with the release ring 41 on the safety pin 72. The aircraft 30 is fitted to the release ring 41 and remains in safety mode.

In FIG. 2, one end 40A of the cord 40 is pegged to the ground, while the release ring 41 at the end 40B of the cord is placed on the safety pin 72. Then, when the user wishes to launch the aircraft, he or she puts the apparatus into launch mode, as in FIG. 7C. This is done by taking the release-ring 41, removing it from the safety pin 72, and then placing it 41 onto the release pin 71.

As seen in FIGS. 8A, 8B1 and 8B2, the release pin 71 is physically connected to the foot-pedal 73. This means that when the foot-pedal is depressed, the release pin 71 will be drawn downwards, so that the release ring 41 is set free.

FIG. 7C shows the apparatus in this release mode, with the release ring 41 on the release pin 71. In this mode, the aircraft 30 is ready to be released when the foot-pedal or spring board 73 is depressed. The instant that the release ring 41 is set free, the model aircraft is pulled along the short runway along by the contraction of the cord 40. Sufficient acceleration and velocity is imparted to the model aircraft by the cord 40 so as to launch the aircraft into flight.

Internal Foot-Pedal

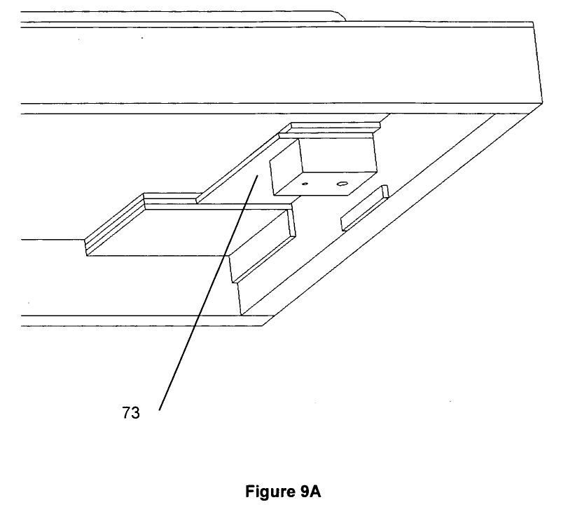

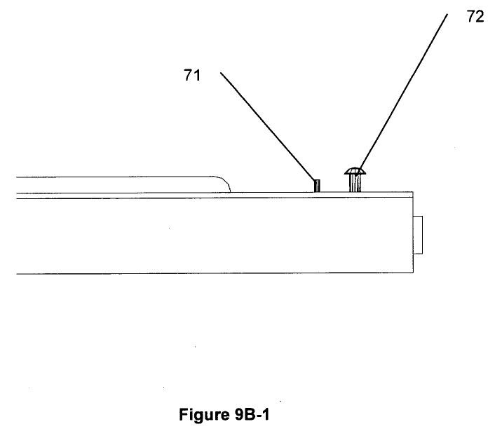

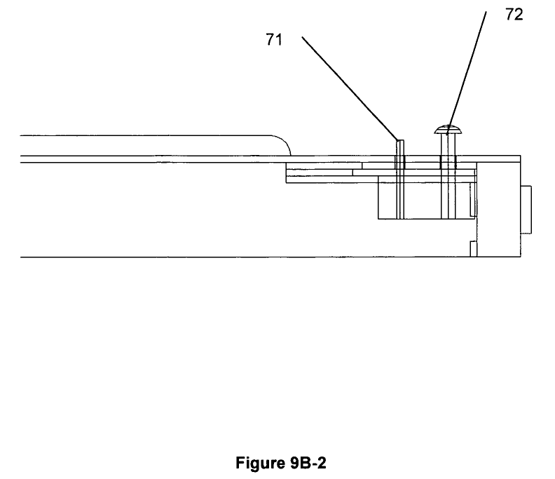

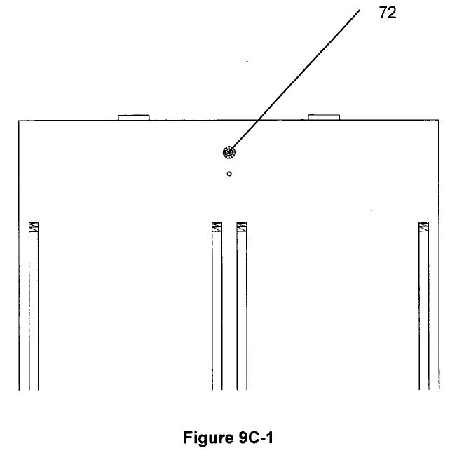

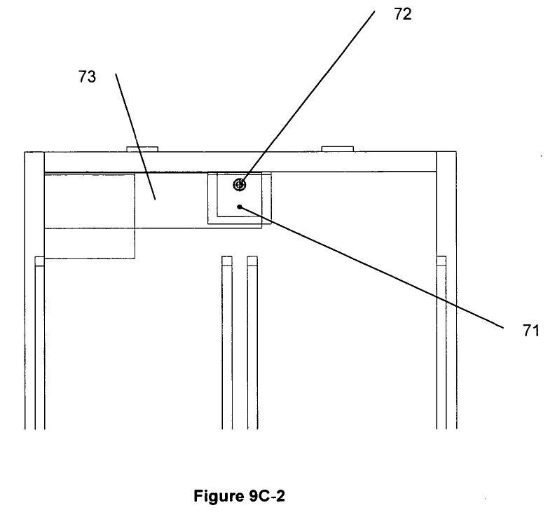

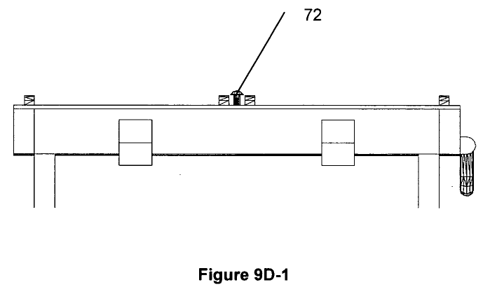

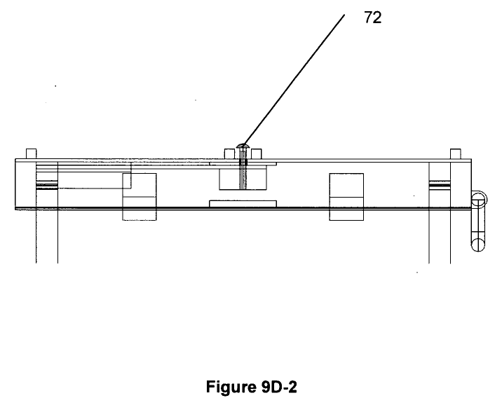

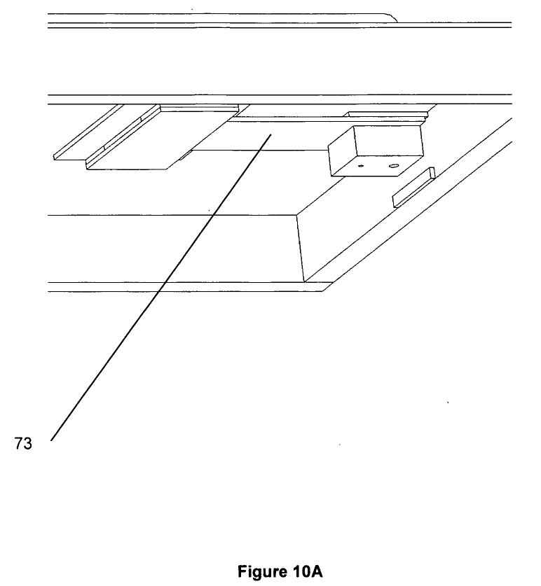

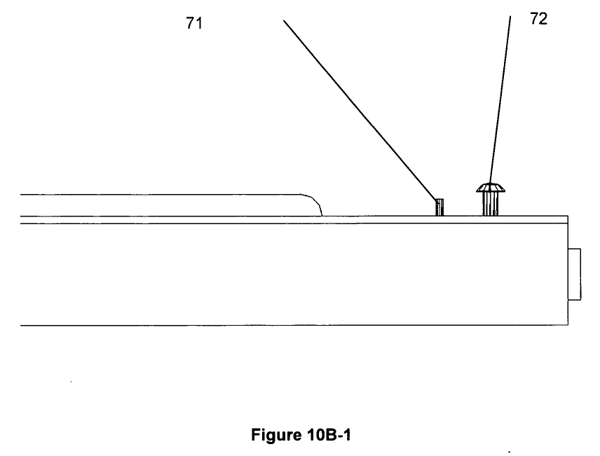

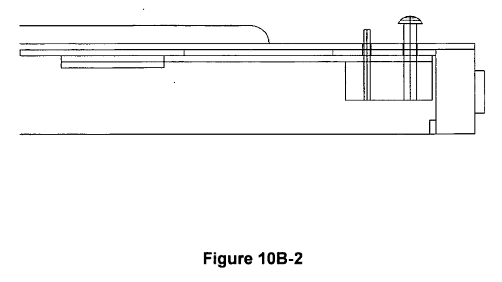

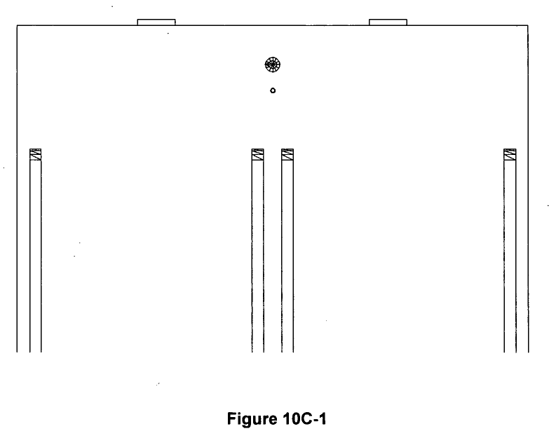

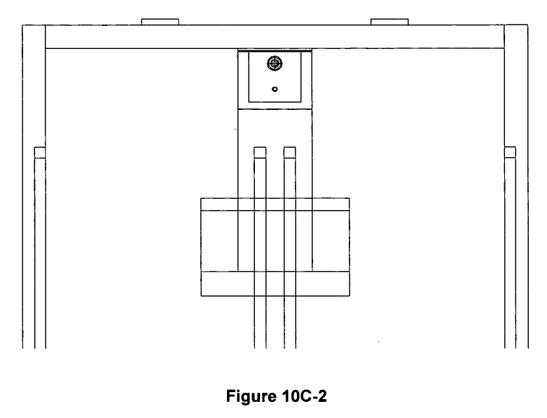

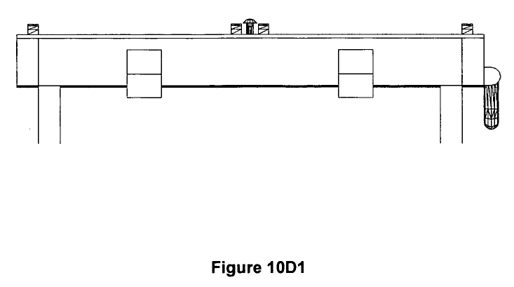

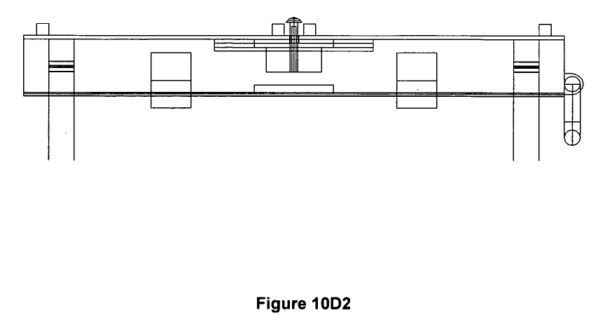

In the above embodiment, the cord-restraining-means is an external component that is separate to the runway apparatus, however, in another embodiment shown in the series of drawings in FIGS. 9 and 10, the cord-restraining-means is an integral component of the apparatus.

In the series of drawings in FIG. 9, the same reference numerals as in the series of FIG. 8, merely in order to aid understanding.

In FIGS. 9A to 9D2, the longitudinal axis of the foot-pedal 73 is arranged transverse to the direction of launch. It operates, however, in a similar manner to the foot-pedal in FIG. 8, in the sense that depression of the foot-pedal in FIGS. 9A to 9D2 causes the lowering of release-pin 71.

Prior to launch, the release ring 41 can be anchored on the safety-pin 72.

In other words, the function of the foot-pedal in the series of FIG. 9 is similar to that of the earlier embodiment, except that, here, the foot-pedal 73 is an integral part of the apparatus and is arranged transversely.

FIGS. 10A, 10B1, 10B2, 10C1, 10C2, 10D1 and 10D2 show a further alternative internal release pedal implementation for the box-launching apparatus, in which the longitudinal axis of the foot-pedal 73 is arranged longitudinally to the direction of launch.

### Other Modifications

The apparatus including handle-means in the form of carry-handle 80 which allows the user to hand-carry the launching apparatus when the apparatus is arranged in the storage-arrangement in which it functions as a storage container for the model aircraft.

In other embodiments, rather than using the elastic cord, the launching-force-means can be a motor provided on the model aircraft.

It is found that the length of only the runway-surface 20A may actually of sufficient length for the aircraft to be launched, and hence other embodiments can use just one runway-surface 20A such as in FIG. 6D, or a runway-surface of similar length, propped at an inclined angle for launching the aircraft.

In other embodiments, rather than the cord-restraining means being activated by foot pressure, other modifications can have the cord-restraining means activated by hand, or even electronically or electro-mechanically with possible remote control.

In other embodiments, the two or more runway surface components are able to be arranged in sliding arrangement one with another, similar to the arrangement in a chest of drawers.

In other variations, the box-launcher 10 can be manufactured in various sizes to house different-sized model aircraft with a range of different wing spans or storage forms.

In other embodiments, the foot-activated actuator or the hand-activated actuator need not be in the form of a pedal, but may be configured as a switch, lever, pressure-pad, or other mechanism or device for actuating the device.

The embodiments have been described, by way of example only, and modifications are possible within the scope of the invention as defined by the appended claims.

The present invention, as defined by the appended claims, excludes any apparatus that are not specifically designed to function as a launching apparatus for model aircraft.

What is claimed is:

1. A launching apparatus which provides a short runway for launching a flying model aircraft, the apparatus including:
at least one runway-surface-component which has a runway-surface-portion,
wherein, in use in a launch-arrangement, the runway-surface-portion functions as a short runway on which a model aircraft can be launched,
wherein the at least one runway-surface-component is provided with container-means adapted to function as a storage container for the model aircraft when the apparatus is in a storage-arrangement and not in use for launching.

2. The launching apparatus of claim 1 including two or more runway-surface-components each having a runway-surface-portion,
wherein, in use in the launch-arrangement, each of the runway-surface-portions combine to form said short runway, and
wherein the two or more runway-surface-components each is provided with container-means such that, when the apparatus is in the storage-arrangement and not in use for launching, the container-means of each of the two or more runway-surface-components combine to form said storage container for the model aircraft.

3. The launching apparatus of claim 2 wherein the two or more runway surface portions, in use in the launch-arrangement, are arranged side by side to form said short runway.

4. The launching apparatus of claim 2 wherein the two or more runway surface components are pivotally connected one to another.

5. The launching apparatus of claim 4 wherein the two or more runway surface components are pivotally connected by a hinge mechanism.

6. The launching apparatus of claim 4 wherein the apparatus has two runway surface components that are operable between the launch-arrangement and the storage-arrangement in a manner of a V-shaped hinge.

7. The launching apparatus of claim 4 wherein the apparatus has three runway surface components that are operable between the launch-arrangement and the storage-arrangement in a manner of two V-shaped hinges each located at either end of a central component.

8. The launching apparatus of claim 2 wherein the two or more runway surface components are able to be arranged in sliding arrangement one with another.

9. The launching apparatus of claim 2 wherein the two or more runway surface components are fastenable to each other when in either the launch-arrangement for launching, or the storage-arrangement for storage, but are otherwise disconnected.

10. The launching apparatus of claim 1 wherein, in use, the short runway includes linear-guide-means for guiding the aircraft along the runway during launching.

11. The launching apparatus of claim 10 wherein the linear-guide-means includes one or more track elements.

12. The launching apparatus of claim 10 wherein the linear-guide-means includes one or more linear grooves.

13. The launching apparatus of claim 1 wherein the aircraft is launched from the launching apparatus by launching-force-means.

14. The launching apparatus of claim 13 wherein the launching-force-means is an elastic cord connectable to the model aircraft.

15. The launching apparatus of claim 14 wherein the apparatus is provided with cord-restraining-means adapted, in use prior to launching, to hold and restrain the elastic cord.

16. The launching apparatus of claim 15 wherein the cord-restraining-means is releasable by a foot-activated actuator.

17. The launching apparatus of claim 15 wherein the cord-restraining-means is releasable by a hand-activated actuator.

18. The launching apparatus of claim 15 wherein the cord-restraining-means is an external component that is separate to the apparatus.

19. The launching apparatus of claim 15 wherein the cord-restraining-means is an integral component of the apparatus.

20. The launching apparatus of claim 16 or 17 wherein the apparatus is further provided with safety-cord-restraining-means adapted, in use prior to launching, to hold and restrain the elastic cord independently of the cord-restraining-means.

21. The launching apparatus of claim 13 wherein the launching-force-means is a motor on the model aircraft.

22. The launching apparatus of claim 1 wherein the apparatus includes three or more runway surface component.

23. The launching apparatus of claim 1 wherein the apparatus further includes a handle-means to allow a user to hand-carry the launching apparatus when the apparatus is arranged in the storage-arrangement.

24. The launching apparatus of claim 1 wherein the storage-arrangement is useable as a transport-arrangement for transporting the apparatus.

25. A launching apparatus that is provided with a runway surface which, in use, is used to launch a flying model aircraft wherein the launching apparatus is provided with a cavity to store the model aircraft therein when the launching apparatus is not in use.

26. Use of a launching apparatus to launch a flying model aircraft from a runway surface provided on the launching apparatus and use of the same launching apparatus to store the flying model aircraft within the launching apparatus.

27. Use of a launching apparatus wherein the launching apparatus is as claimed in claim 1.

28. A method of launching a model aircraft from a launching apparatus and storing the aircraft in the same apparatus, the method comprising:
providing a launching apparatus which, in a launch-arrangement, provides a runway for launching a flying model aircraft, the launching apparatus including at least one runway-surface-component having a runway-surface-portion that functions as the runway;
launching the aircraft from the runway-surface-portion; and
re-arranging the launching apparatus into a storage-arrangement and storing the aircraft in container-means that is included in the at least one runway-surface-component.

29. The method of claim 28 wherein the launching apparatus is in accordance with claim 1.
